(19) United States
(12) Patent Application Publication
(10) Pub. No.: US 2021/0048101 A1
(43) Pub. Date: Feb. 18, 2021

(54) ROTARY SHIFTER

(71) Applicant: NORTH KUSTOM FABRICATION OY, Kangasala (FI)

(72) Inventor: Janne Kalevi VEPSÄ, Kangasala (FI)

(73) Assignee: NORTH KUSTOM FABRICATION OY, Kangasala (FI)

(21) Appl. No.: 16/992,450

(22) Filed: Aug. 13, 2020

(30) Foreign Application Priority Data
Aug. 16, 2019 (FI) 20195687

(51) Int. Cl. F16H 59/08; F16H 59/04

(52) U.S. Cl. CPC F16H 59/08; F16H 2059/081; F16H 59/042

(57) ABSTRACT

A rotary shifter for an automatic transmission is disclosed. The rotary shifter has two rack-and-pinion assemblies in the same axle, which is rotatable by a knob. The rack-and-pinion assemblies are aligned to move the same gear cable, but the teeth positions are different on both assemblies. The dual rack-and-pinion assembly having the same actuating direction ensures that the rotary shifter action remains free from slack movement. A pressing member for exerting a force between the pinion and the rack may be used to further improve the action. The pressing member improves the contact between the rack and the pinion. Having different teeth positions on the aligned racks ensures that the pinion teeth, while configured to interact with the respective racks, are in contact with rack teeth with alternate positions on the respective racks.

### BACKGROUND

This disclosure relates to the field of automotive automatic transmission systems. More particularly, the disclosure pertains to driver interface features for selecting and displaying a transmission drive range.

Automatic transmissions in automobiles comprise selectable drive modes, such as park, reverse, neutral and drive. A driver controls the drive modes via a shifter. Shifters are known in various embodiments, such as floor selection levers, steering column levers or rotary shifters.

Classic cars are often customized with new aftermarket components. The custom cars may employ various styles, wherein the interior and/or exterior is modified drastically. The aftermarket components may be interchangeable with the factory original components. The gear shifter is one example of customization on classic cars. The original gear lever may be replaced with a rotary shifter.

The customization projects may incorporate technology or parts that were not available at the original manufacturing date. Therefore, it is important that the rotary shifter has compact dimensions that enable fitting the rotary shifter in a customized cockpit.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A rotary shifter for an automatic transmission is disclosed. The rotary shifter has two rack-and-pinion assemblies in the same axle, which is rotatable by a knob. The two rack-and-pinion assemblies are aligned to move the same gear cable, but the teeth positions are different on both assemblies. The dual rack-and-pinion assembly having the same actuating direction ensures that the rotary shifter action remains free from slack movement. A pressing member for exerting a force between the pinion and the rack may be used to further improve the action. The pressing member improves the contact between the racks and the pinions. Having different teeth positions on the aligned racks ensures that the pinion teeth, while configured to interact with the respective racks, are in contact with rack teeth with alternate positions on the respective racks. The pressing member may be used to effectively remove any backlash from the assembly.

The dual rack-and-pinion assembly allows the use of thinner and/or smaller components on the rack-and-pinion assembly. The body of the rotary shifter may be made of sheet metal. The same sheet metal material may be used for the pinion-and-rack assemblies, wherein the components may be fabricated by laser cutting. Small components enable constructing the whole rotary shifter with compact dimensions. This, in turn, allows a flexible cockpit design. Automobile interiors must house several devices for controlling the automotive functions or for entertainment, wherein the usable space may limit the design choices. As one example, the rotary shifter may be placed inside an ashtray or to any other novel placement on the dashboard or the center console. The rotary shifter, as described herein, may be used as a replacement to various floor selection levers, steering column levers or rotary shifters in classic automobiles.

### BRIEF DESCRIPTION OF THE DRAWINGS

The present description will be better understood from the following detailed description read in light of the accompanying drawings, wherein

FIG. 1 illustrates schematically one partial view of one exemplary embodiment of a rotary shifter;

FIG. 2 illustrates schematically an alternative view of the rotary shifter;

FIG. 3 illustrates schematically two alternative views of one exemplary embodiment of a dual rack-and-pinion assembly;

FIG. 4a illustrates schematically a partial view of a first operational position of one exemplary embodiment;

FIG. 4b illustrates schematically a partial view of a second operational position of one exemplary embodiment; and

FIG. 5 illustrates schematically components of the automatic transmission system with the rotary shifter.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. However, the same or equivalent functions and sequences may be accomplished by different examples.

Although the present examples are described and illustrated herein as being implemented in controlling the automatic transmission from the dashboard, they are provided as an example and not a limitation. As those skilled in the art will appreciate, the present examples are suitable for application in a variety of different types of rotary shifter placements and/or solutions for illustrating the selected transmission mode.

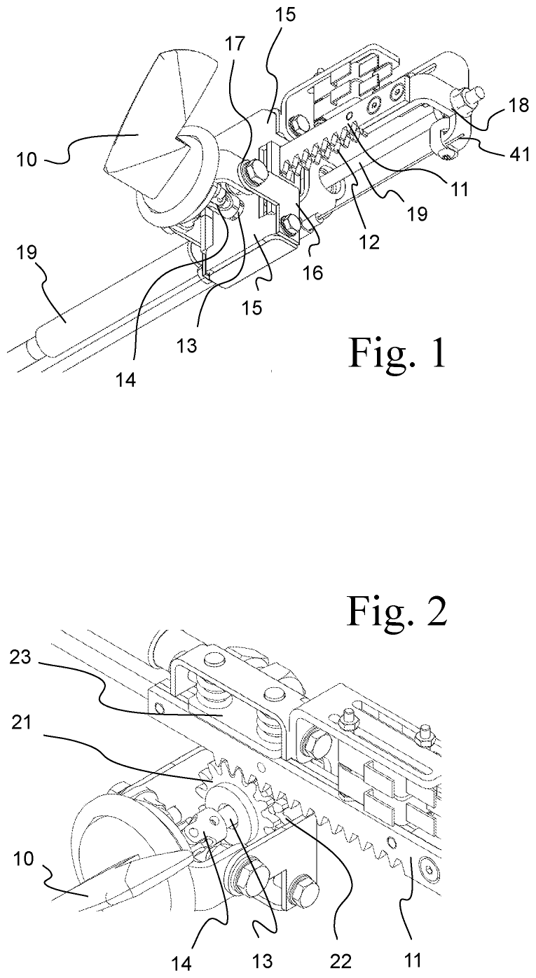

One exemplary embodiment of the rotary shifter is illustrated schematically in FIG. 1. A knob 10 is connected to a pinion axle 13. The knob 10 is mechanically linked to an automatic transmission. A driver uses the knob 10 to select the transmission mode; in other words, the knob 10 is a shift selector. Examples of typical transmission modes are park, reverse, neutral and drive. Some embodiments may comprise additional transmission modes, such as low gear, economic transmission mode or sport transmission mode. In this example, the pinion axle 13 is connected to the knob 10 via a joint 14, for example a universal joint. The joint 14 enables installing the knob 10 to a different angle from the pinion axle 13. In some embodiments, the connection between the knob 10 and the pinion axle 13 may comprise flexible cables or other means for transmitting rotational movement between the knob 10 and the pinion axle 13.

The knob 10 is connected to a body 15 via brackets 16 configured to support the knob 10. The brackets 16 are equipped with lockable hinges 17 that allow the knob 10 to be fixedly installed at multiple angles.

FIG. 2 is a second projection to the embodiment of FIG. 1. The pinion axle 13 is connected to two pinions, a first pinion 21 and a second pinion 22. The first pinion 21 comprises a plurality of first pinion teeth in a first orientation and the second pinion 22 comprises a plurality of second pinion teeth in a second orientation. In the present example, the first pinion 21 and the second pinion 22 are identical. In other embodiments, the number and/or the size of the first pinion teeth may differ from the number and/or the size of the second pinion teeth.

A first rack 11 is slidingly connected to the body 15. A gear cable connector 18 is connected to a first end of the first rack 11, wherein the second end of the first rack 11 is supported by the first pinion 21 and a guide configured to the body 15. The guide may be integrated to a pressing member 23. The first rack 11 comprises a plurality of first rack teeth. The first rack 11 is configured to move transversely to the pinion axle 13 wherein the first rack teeth are configured to interact with the plurality of first pinion teeth. Rotating the knob 10 causes the first pinion 21 to rotate and the first pinion teeth cause, via the first rack teeth, the first rack 11 to move in the linear direction along the longitudinal axis of the first rack 11. The linear movement causes the gear cable connector 18 to move a gear cable 19.

A second rack 12 is aligned with and connected to the first rack 11, wherein they form a rack assembly, slidingly connected to the body 15. The second rack 12 moves along the first rack 11. In a similar manner as the first rack 11, the gear cable connector 18 is connected to a first end of the second rack 12, wherein the second end of the second rack 12 is supported by the second pinion 22 and the guide configured to position the racks 11, 12. The second rack 12 comprises a plurality of second rack teeth. In the present example, the first rack 11 and the second rack 12 are identical. In other embodiments, the number and/or the size of the first rack teeth may differ from the number and/or the size of the second rack teeth.

The second rack 12 is configured to move transversely to the pinion axle 13 wherein the second rack teeth are configured to interact with the plurality of second pinion teeth. Rotating the knob 10 causes the second pinion 22 to rotate and the second pinion teeth cause, via the second rack teeth, the second rack 12 to move in the linear direction along the longitudinal axis of the second rack 12. The linear movement causes the gear cable connector 18 to move the gear cable 19. In the examples where the teeth sizes between the first pinion 21 and the second pinion 22 are different, the first rack 11 and the second rack 12 comprise compatible teeth with the corresponding pinion. The gear ratio may be similar on both rack-and-pinion assemblies.

The teeth of the first rack 11 are fixedly offset to the teeth of the second rack 12. As the first pinion 21 and the second pinion 22 have fixed and different orientations, the teeth of the first rack-and-pinion assembly 11, 21 operate always at a different phase than the teeth on the second rack-and-pinion assembly 12, 22. The phase differential reduces possible backlash on the dual rack-and-pinion assembly.

In one embodiment, at least one component of the group comprising the first pinion 21, the second pinion 22, the first rack 11 and the second rack 12 are made of sheet metal. The sheet metal may be cut with a laser. The offset dual rack-and-pinion assembly exerts the forces evenly to the teeth, enabling a simple structure to the racks and pinions. In one embodiment, the body 15 is made of sheet metal. The sheet metal of the body 15 and of the first pinion 21, the second pinion 22, the first rack 11 and the second rack 12 may comprise the same thickness and/or be the same material.

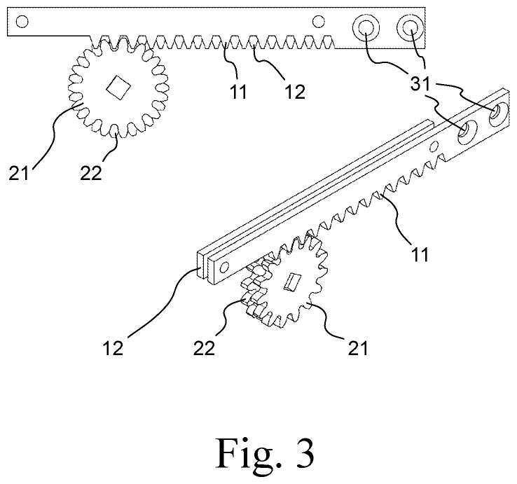

FIG. 3 illustrates schematically two projections of one exemplary embodiment of the dual rack-and-pinion assembly. The first rack 11 and the second rack 12 are aligned with the plurality of teeth in different positions. The second rack 12 is fixedly connected to the first rack 11 with a distance between the teeth of the two racks 11, 12. The first rack 11 is longer than the second rack 12 in the illustration, but either the first rack 11, the second rack 12 or both may comprise means for connecting to the gear cable connector 18. Also, the first pinion 21 and the second pinion 22 are aligned with the plurality of teeth in different positions, said teeth positioned to interact with the first rack 11 and the second rack 12. In the example of FIG. 3, the two assemblies operate in opposite phases. In other embodiments, the phase difference between the two assemblies may differ from the completely opposite phase difference of the present example.

In one embodiment, the rotary shifter comprises a pressing member 23 configured to improve the contact between the pinions 21, 22 and the racks 11, 12. The pressing member 23 may exert force either to the pinions 21, 22 or to the racks 11, 12, causing the first rack 11 and the second rack 12 to be in contact with the first pinion 21 and the second pinion 22. In the present example, the pressing member 23 pushes the racks 11, 12 towards the pinions 21, 22. In one embodiment, the pressing member 23 comprises a slider that pushes the racks 11, 12 towards the pinions 21, 22. The slider may be a solid component with a low frictional coefficient. In one embodiment, the slider is made of polyoxymethylene. In one embodiment, the pressing member 23 is made of polyoxymethylene. In one embodiment, the pressing member 23 comprises a roller. In one embodiment, the pressing member 23 is a roller configured to roll on the racks 11, 12. In one embodiment, the pressing member 23 comprises a spring configured to exert said force causing the racks 11, 12 to be in contact with the pinions 21, 22. The pressing member may comprise a guide configured to retain the racks 11, 12 laterally in contact with the pinions 21, 22.

In one embodiment, the pressing member 23 comprises a screw configured to exert said force and/or to adjust the force. If the slider or any other component wears out, the screw may reposition the slider and return the action of the dual rack-and-pinion assembly. The screw adjustment may be set manually to optimal tightness. The body 15 may support the pinion axle 13, the first rack 11, the second rack 12 and the pressing member 23.

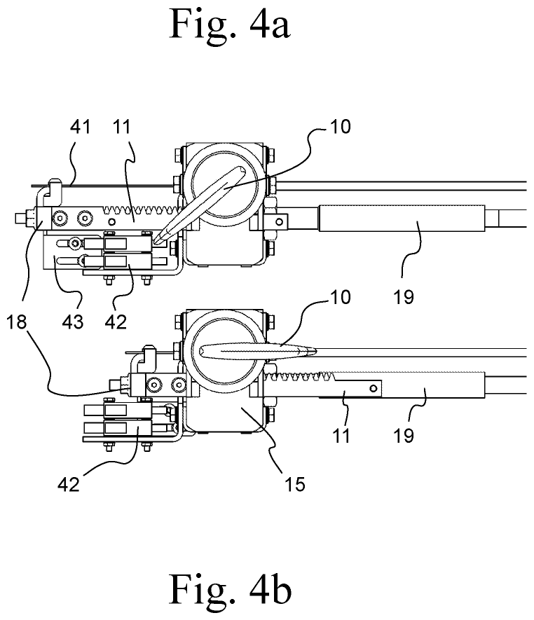

FIG. 4a and FIG. 4b illustrate schematically two operational positions of one exemplary embodiment. In FIG. 4a, the knob 10 is in a first extreme position, wherein the first rack 11 and the gear cable 19, via the gear cable connector 18, are fully extended. The gear cable connector 18 is also connected to the gear shift indicator cable 41. The gear shift indicator cable 41 is configured to move along the gear cable 19 and provide information of the automatic transmission mode to a separate dial or display which may be positioned elsewhere in the automotive interior, for example to the dashboard. The dial or the display provides visual information of the selected transmission mode. The gear shift indicator cable 41 follows the knob's 10 movements. In one embodiment, the knob 10 provides the visual information of the transmission mode.

In FIG. 4b, the knob 10 is in a second extreme position, wherein the first rack 11 and the gear cable 19, via the gear cable connector 18, are fully retracted. All selectable transmission modes are between the first extreme position and the second extreme position. The number of transmission modes depends on the automatic transmission. The travel of the gear cable 19 between the first extreme position and the second extreme position may be configured by the gear ratio of the rack-and-pinion assembly and/or the length of the racks 11, 12.

In some embodiments, the rotary shifter comprises electrical components. The transmission mode information may be transmitted to the automotive control system. As one example, the car may not start unless the gear is in park mode. In one exemplary embodiment, the cable connector 18 is configured to move a contact 43 for interacting with a switch 42 that is fixedly connected to the body 15. When the knob 10 is in the second extreme position, in park mode, the contact 43 causes the switch 42 to provide electrical connection to the car ignition, thereby enabling the car to start.

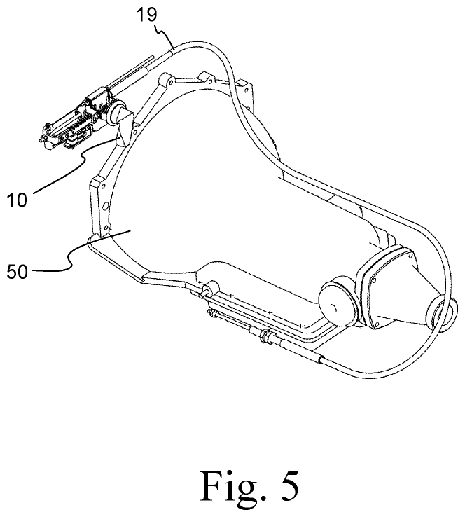

FIG. 5 illustrates schematically the components of the automatic transmission system. The rotary shifter comprising the knob 10 is connected via the gear cable 19 to the automatic transmission 50. The gear cable 19 selects the transmission mode at the automatic transmission according to the cable length corresponding to the position selected by the rotary shifter. The rotary shifter is compact in size, allowing various placements in the vehicle. The gear cable 19 may be hidden inside a car chassis and/or trim.

A rotary shifter is disclosed, comprising a pinion axle; a first pinion connected to the pinion axle, comprising a plurality of first pinion teeth in a first orientation; a first rack comprising a plurality of first rack teeth configured to interact with the plurality of first pinion teeth; a knob connected to the pinion axle, wherein rotating the knob causes the first pinion to rotate; a gear cable connector connected to the first rack, wherein rotating the knob causes linear movement to the gear cable. A second pinion is connected to the pinion axle, comprising the plurality of second pinion teeth in a second orientation. A second rack is aligned with the first rack and comprising a plurality of second rack teeth configured to interact with the plurality of second pinion teeth. The second rack is connected to the gear cable connector. In one embodiment, a pressing member is configured to exert force causing the first rack and the second rack to be in contact with the first pinion and the second pinion. In one embodiment, the pressing member comprises a slider. In one embodiment, the pressing member is made of polyoxymethylene. In one embodiment, the pressing member comprises a roller. In one embodiment, the pressing member comprises a spring configured to exert said force. In one embodiment, the pressing member comprises a screw configured to exert said force. In one embodiment, a body is configured to support the pinion axle, the first rack, the second rack and the pressing member. In one embodiment, the body is made of sheet metal. In one embodiment, the first pinion, the second pinion, the first rack and the second rack are made of sheet metal. In one embodiment, a portion of the body is configured to support the knob. In one embodiment, the portion of the body supporting the knob comprises a hinge allowing rotation in the connection to the pinion axle.

Alternatively, or in addition, the automatic transmission control function or ignition control function can be performed, at least in part, by one or more hardware components or hardware logic components. The information may be transmitted at least partially to automotive control systems. An example of the control function is a computer-based device comprising one or more processors which may be microprocessors, controllers or any other suitable type of processors for processing computer-executable instructions to control the operation of the device in order to control one or more sensors, receive sensor data and utilize the sensor data. The control system may be positioned on the host system and connected to the apparatus. The computer-executable instructions may be provided using any computer-readable media that is accessible by a computer-based device. Computer-readable media may include, for example, computer storage media, such as memory and communications media. Computer storage media, such as memory, includes volatile and non-volatile, removable and non-removable media implemented in any method or technology for storage of information, such as computer-readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media is shown within the computing-based device, it will be appreciated that the storage may be distributed or located remotely and accessed via a network or other communication link, for example, by using a communication interface.

The apparatus or the device may comprise an input/output controller arranged to output display information to a display device which may be separate from or integral to the apparatus or device. The input/output controller is also arranged to receive and process input from one or more devices, such as a user input device (e.g. a mouse, keyboard, touchpad, camera, microphone or other sensor).

Any range or device value given herein may be extended or altered without losing the effect sought.

Although at least a portion of the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The term ‘comprising’ is used herein to mean including the elements identified, but that such elements do not comprise an exclusive list and an apparatus may contain additional elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A rotary shifter, comprising:
a pinion axle;
a first pinion connected to the pinion axle, comprising a plurality of first pinion teeth in a first orientation;
a first rack comprising a plurality of first rack teeth configured to interact with the plurality of first pinion teeth;
a knob connected to the pinion axle, wherein rotating the knob causes the first pinion to rotate;
a gear cable connector connected to the first rack, wherein rotating the knob causes linear movement to the gear cable;
a second pinion connected to the pinion axle, comprising the plurality of second pinion teeth in a second orientation;
a second rack aligned with the first rack and comprising a plurality of second rack teeth configured to interact with the plurality of second pinion teeth; and
the second rack is connected to the gear cable connector.

2. A rotary shifter according to claim 1, comprising a pressing member configured to exert force causing the first rack and the second rack to be in contact with the first pinion and the second pinion.

3. A rotary shifter according to claim 1, wherein the pressing member comprises a slider.

4. A rotary shifter according to claim 3, wherein the pressing member is made of polyoxymethylene.

5. A rotary shifter according to claim 1, wherein the pressing member comprises a roller.

6. A rotary shifter according to claim 2, wherein the pressing member comprises a spring configured to exert said force.

7. A rotary shifter according claim 2, wherein that the pressing member comprises a screw configured to exert said force.

8. A rotary shifter according to claim 1, comprising a body configured to support the pinion axle, the first rack, the second rack and the pressing member.

9. A rotary shifter according to claim 8, wherein the body is made of sheet metal.

10. A rotary shifter according to claim 1, wherein the first pinion, the second pinion, the first rack and the second rack are made of sheet metal.

11. A rotary shifter according to claim 1, wherein a portion of the body is configured to support the knob.

12. A rotary shifter according to claim 1, wherein a portion of the body supporting the knob comprises a hinge allowing rotation in the connection to the pinion axle.
